(19) United States
(12) Patent Application Publication
(10) Pub. No.: US 2013/0220349 A1
(43) Pub. Date: Aug. 29, 2013

(54) DEFORMABLE TABLET WITH WATER TRIGGERED CATALYST RELEASE

(71) Applicants: Raymond M. Robertson, Blacksburg, VA (US); William C. Thomas, Pembroke, VA (US)

(72) Inventors: Raymond M. Robertson, Blacksburg, VA (US); William C. Thomas, Pembroke, VA (US)

(73) Assignee: Celanese Acetate LLC, Dallas, TX (US)

(21) Appl. No.: 13/402,970

(22) Filed: Feb. 23, 2012

(51) Int. Cl. A24D 3/14; B01J 31/06; B01J 37/36; A24F 1/02

(52) U.S. Cl. 131/207; 131/332; 131/202; 502/159; 502/7

(57) ABSTRACT

A tablet contains reagents with catalytic activity, release of which is triggered by exposure of the tablet to water. A malleable capsule includes: (a) a flexible polymer; (b) a plasticizer; and (c) a catalyst disposed within the capsule, wherein a portion of the catalyst is released from the capsule upon exposure of the capsule to water.

### BACKGROUND

The present invention relates to tablets containing reagents with catalytic activity, and more specifically to the triggered release of such reagents from such tablets upon exposure to water.

Cellulose esters used in cigarette filters in the form of a bloomed cellulose acetate tow will degrade over time, although this may take many years. After a cigarette has been smoked, the cigarette filter is frequently discarded improperly and becomes an unsightly piece of litter and/or potentially an environmental biohazard.

Cellulose esters are also used in other applications such as high absorbency disposable products, such as diapers and in various surgical products. Even with proper disposal such products may occupy landfills requiring protracted periods of time to degrade.

Cellulose acetate, in particular, is used to make a variety of consumer products including textiles, plastic films, and cigarette filters. While cellulose itself is readily biodegraded, for example, by various organisms employing cellulase enzymes, the acetate groups of cellulose acetate may prevent an otherwise useful organism from degrading such products absent an appropriate esterase. Even partial deacetylation of cellulose acetate products may facilitate biodegradation of the cellulose backbone.

### SUMMARY OF THE INVENTION

The present invention relates to tablets containing reagents with catalytic activity, and more specifically to the triggered release of such reagents from such tablets upon exposure to water.

In some embodiments, the present invention provides a malleable capsule comprising (a) a flexible polymer; (b) a plasticizer; and (c) a catalyst disposed within the capsule, wherein a portion of the catalyst is released from the capsule upon exposure of the capsule to water.

In some embodiments, the present invention provides a malleable capsule comprising (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, the present invention provides a smoking device filter comprising a malleable capsule disposed within a first section of the smoking device filter, the capsule comprising (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, the present invention provides a smoking device comprising a smoking device filter comprising a malleable capsule disposed within a first section of the smoking device filter, the capsule comprising (a) a flexible polymer; (b) a plasticizer; (c) an ester hydrolysis catalyst disposed within the capsule, wherein a portion of the catalyst is released from the capsule upon exposure of the capsule to water; and (d) at least one water permeable coating disposed about the capsule, wherein the smoking device further comprises a housing capable of maintaining a smokeable substance in fluid contact with the smoking device filter.

In some embodiments, the present invention provides a pack of filters comprising a pack comprising at least a plurality of filters, the filters comprising at least one malleable capsule disposed within a first section of the filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, the present invention provides a method of forming a pack of smoking devices comprising providing at least one smoking device that comprises a filter, the filter comprising at least one malleable capsule disposed within a first section of the filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, the present invention provides a pack of smoking devices comprising: a pack comprising at least one smoking device that comprises a filter, the filter comprising at least one malleable capsule disposed within a first section of the filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, the present invention provides a carton of smoking device packs comprising: a carton comprising at least one pack, the pack comprising at least one smoking device that comprises a filter, the filter comprising at least one malleable capsule disposed within a first section of the filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, the present invention provides a method of smoking a smoking device, the method comprising: heating a smoking device to form smoke, wherein the smoking device comprises at least one filter section comprising at least one malleable capsule disposed within a first section of the filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water, and drawing the smoke through the smoking device.

In some embodiments, the present invention provides a method for making a filter rod, the filter rod being usable in a smoking device, the method comprising: providing a first filter section; and disposing at least one malleable capsule within the first filter section, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, the present invention provides a method of making a smoking device, the method comprising: providing a filter rod comprising at least one filter section that comprises at least one malleable capsule disposed within a first section of the filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water, providing a tobacco column, cutting the filter rod transverse to its longitudinal axis through the center of the rod to form at least two smoking device filters having at least one filter section that comprises a porous mass that comprises an active particle and a binder particle, and joining at least one of the smoking device filters to the tobacco column along the longitudinal axis of the filter and the longitudinal axis of the tobacco column to form at least one smoking device.

In some embodiments, the present invention provides a method of making a smoking device, the method comprising: providing a tobacco column; and joining a filter to the tobacco column, wherein the filter comprises at least one malleable capsule disposed within a first section of the filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to those skilled in the art and having the benefit of this disclosure.

FIG. 1 shows a malleable capsule with a coating, in accordance with embodiments of the invention.

FIG. 2 shows a malleable capsule comprising a two-layered coating, in accordance with embodiments of the invention.

FIG. 3 shows a smoking filter device comprising a malleable capsule disposed in the vicinity of a cellulose acetate tow, in accordance with embodiments of the invention.

FIG. 4 shows a smoking filter device comprising a malleable capsule disposed within a cellulose acetate tow, in accordance with embodiments of the invention.

### DETAILED DESCRIPTION

The present invention relates to tablets containing reagents with catalytic activity, and more specifically to the triggered release of such reagents from such tablets upon exposure to water.

Of the many advantages, the present invention provides tablets in the form of malleable coated capsules containing reagents with catalytic activity, in particular embodiments, with activity facilitating the hydrolysis of cellulose esters, that may aid in the degradation of various consumable products comprising cellulose esters. The release of such reagents from the tablet may be triggered upon exposure to water. In some such embodiments, the requisite water may be provided upon environmental exposure. Further in some such embodiments, the release of such reagents may facilitate the degradation of cellulose esters in a manner of hours, days, weeks, or months, rather than years in the absence of the catalytic reagent. The actual time of degradation may depend on the exact choice of catalytic material, environmental conditions such as temperature, as well as relative humidity.

Tablets of the invention may be provided as malleable coated capsules in a variety of sizes. Such sizes may be selected based on the end application and in some such embodiments, a plurality of tablets may be employed. Where a plurality of tablets is used, the plurality may be distributed in a consumable product at areas of the article where cellulose esters are present.

In particular embodiments, tablets of the invention may be configured for incorporation in a filter of a cigarette to provide a consumable cigarette product, the components of which, including the filter are fully biodegradable upon release of the encapsulated catalyst. In some such embodiments, the tablet may be a single pill-like form, or alternatively, a plurality of smaller tablets.

Compositions of the invention, while described generally as a “tablet” or “capsule,” are made from materials that may exhibit sufficient flexibility and formability to be employed in non-tablet format, including, for example, as coated sheets, multilayer films, and in other three-dimensional shapes as otherwise suits the end consumable product. In this regard, the compositions described herein may be used in various products without impacting their function or form as perceived by the end user.

Tablets of the invention comprising malleable coated capsules are, in some embodiments, compatible with any number of coating strategies known in the art, including, without limitation, delayed release coatings, sustained slow-release coatings, or other modified release characteristics. In some embodiments, the coatings may be configured for catalyst release upon exposure to water with a particular pH profile and/or exposure to water with a particular temperature profile, or a combination of water pH and temperature. Given the guidance provided herein, other advantages will be apparent to the skilled artisan.

In some embodiments, the present invention provides malleable capsules comprising: (a) flexible polymers; (b) plasticizers; (c) ester hydrolysis catalysts disposed within the capsules; and (d) at least one water permeable coating disposed about the capsules, wherein a portion of the catalyst is released from the capsules upon exposure of the capsules to water.

In some embodiments, the capsules of the invention comprise a malleable coated capsule that is substantially spherical. In some such embodiments, one or more malleable capsules are disposed within a cellulose acetate tow of a cigarette filter. The “effective spherical diameter,” recognizing natural deviations from perfect spherical geometry, of the coated capsule may correspond to the diameter of filter being used which, in turn, may be a function of the cigarette size. In some embodiments, the malleable coated capsule of the invention that is substantially spherical has an effective spherical diameter in a range from about 500 microns to about 25 mm, including any value inbetween or fraction thereof. In some embodiments, the effective spherical diameter is in a range from about 5 mm to about 20 mm, or from about 10 mm to about 20 mm, including any nested range inbetween, including fractions thereof. In some embodiments, the effective spherical diameter is in a range from about 500 microns to about 5 mm. In some embodiments, the effective spherical diameter is in a range from about 5 mm to about 10 mm, from about 10 mm to about 15 mm, from 15 mm to about 20 mm, or from about 20 mm to about 25 mm, including any nested range inbetween, including fractions thereof. In some embodiments, the effective spherical diameter is about 500 microns, about 1mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, or about 25 mm, including fractions thereof.

In some embodiments, the capsules of the present invention include a base material that comprises a flexible polymer. The flexible polymer may serve as a holding matrix for the catalyst. Flexible polymers include any polymer providing malleability, alone or in conjunction with a plasticizer, and at least some retention capacity for the encapsulated catalyst. In some such embodiments, the flexible polymer is any polymer having at least some elastic behavior. In some embodiments, the flexible polymer comprises foams. For example, foams may include biodegradable foams including those based on grain sorghum or corn starch, such as foams used as packing peanut material. In some embodiments, the flexible polymer may comprise gelling agents. In some embodiments, the flexible polymer may comprise gelatins. In some embodiments, the flexible polymer comprises gels. In some embodiments, the flexible polymer may be designed to swell upon exposure to large quantities of water, such that the swelling of the flexible polymer aids in the release of the ester hydrolysis catalyst.

One guideline for selection of a flexible polymer is that it is itself a biodegradable material. As used herein, “biodegradable” refers to a material capable of being broken down into environmentally innocuous products by the action of one or more microbial organisms. In some embodiments, any of the materials that may be beneficially biodegraded might also be environmentally degraded into innocuous products via non-microbial action. For example, in some embodiments, exposure to natural metal salts in the environment in conjunction with water, or other possible catalytic species may assist in effecting environmental degradation. Other environmental conditions assisting in degradation may include, for example, temperature and/or exposure to light. In some embodiments, any of the materials that may be beneficially biodegraded or environmentally degraded, may also be degraded under controlled conditions, for example, at a waste recycling facility or the like.

In some embodiments, capsules of the invention may comprise flexible polymers selected from the group consisting of gelatin, chitosan, locust bean gum, starch, pectin, agar, alginic acid, salts of alginic acid, carrageenans, sorghum, thermal polyaspartate (TPA), polyvinyl alcohol, polyvinyl acetate (PVAc), polylactic acid (PLA), polyglycolic acid (PGA), polybutylene succinate (PBS), polyhydroxy-alkanoate (PHA) such as poly-3-hydroxypropionate (p(3-HP)), polycaprolactone (PCL) and any combination thereof or copolymer thereof or derivative thereof.

In some embodiments, capsules of the present invention provide for the flexible polymer being present in a range from between about 10 to about 75 weight percent of the capsule. In some embodiments, the flexible polymer is present in about 10 weight percent, about 15, about 20, about 25, about 30, about 35, about 40, about 50, about 55, about 60, about 65, about 70 and about 75 weight percent of the capsule, including all values inbetween and fractions thereof.

In some embodiments, capsules of the present invention may further comprise plasticizers. The plasticizer may be any material that helps to impart malleability to the capsule. Although, the plasticizer may be any agent fulfilling this role, in some embodiments, the plasticizer is also selected to be biodegradable. In some embodiments, capsules of the invention include a plasticizer selected from the group consisting of sorbitol, glycerin, and mixtures thereof. Other plasticizers that may be employed and which are generally regarded as safe and/or biodegradable include, without limitation, acetylated monoglycerides, alkyl citrates, such as triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC, trihexyl o-butyryl citrate), and trimethyl citrate (TMC), alkyl sulphonic acid phenyl esters (ASEs), and 1,2-cyclohexane dicarboxylic acid diisononyl ester. Any of the aforementioned plasticizers may be used alone or in combination.

In some embodiments, capsules of the present invention include a plasticizer present in a range from about 5 to about 50 weight percent of the capsule. In some embodiments, the amount of plasticizer is about 5 weight percent, about 10, about 15, about 20, about 25, about 30, about 35, about 40, about 45, or about 50 weight percent of the capsule, including any value inbetween and fractions thereof. One skilled in the art will recognize that the amount of plasticizer may be a function of the choice of flexible polymer. In some embodiments, the flexible polymer alone exhibits the desired malleability and a plasticizer is not needed. In some embodiments, a ratio of flexible polymer to plasticizer is in a range from about 50:50 to about 95:5, including about 50:50, about 60:40, about 70:30, about 85:15, and about 95:5, and any ratio inbetween.

In some embodiments, the ester hydrolysis catalyst in capsules of the invention includes any material or combination of materials that may catalyze hydrolysis of cellulose esters. “Catalyze hydrolysis,” as used herein, refers to the hydrolytic cleavage of an ester moiety on the cellulose backbone. In some embodiments, all ester moieties are cleavable by action of the ester hydrolysis catalyst, although such a condition is not necessary for cellulose breakdown. With respect to cellulose acetate, in particular, a degree of substitution (D.S.) of about 0.1 to about 1.0 is sufficient for subsequent biodegradation, for example, by naturally occurring enzymes and bacteria. D.S. refers to the average number of acetate groups per monomeric unit, glucose, or cellulose. For example, cellulose acetate with a D.S. of one has on average one acetate group per glucose monomer. For hydrolysis of the cellulose acetate to occur, only the substrate cellulose acetate, the ester hydrolysis catalyst, and water may be needed.

In some embodiments, capsules of the invention may include ester hydrolysis catalysts selected from the group consisting of acids, salts of polyprotic acids, bases, and bacteria, alone or in any combination. Thus, in some embodiments, mixtures of acids and salts of polyprotic acids may be used. In some embodiments, mixtures of acids and bacteria may be used. In some embodiments mixtures of bases and bacteria may be used. In some embodiments, acids or salts thereof are selected from the group consisting of acetic, ascorbic, ascorbyl-2-phosphate, ascorbyl-2-sulfate, aspartic(aminosuccinic), cinnamic, citric, folic, glutaric, inositol phosphate(phytic acid), lactic, malic(1-hydroxysuccinic), nicotinic(nician), oxalic, succinic, tartaric, boric, hydrochloric, nitric, phosphoric, sulfuric, and combinations thereof.

Ester hydrolysis catalysts may, in some embodiments, include acids, acid salts, bases, and bacterium adapted to generate an acid. In some embodiments, acids may have a pKₐ of less than 6. In some embodiments, bases may have a pK_{b} of less than 6. Exemplary acids include, without limitation, acetic, ascorbic, ascorbyl-2-phosphate, ascorbyl-2-sulfate, aspartic(aminosuccinic), cinnamic, citric, folic, glutaric, inositol phosphate(phytic acid), lactic, malic(1-hydroxysuccinic), nicotinic(nician), oxalic, succinic, tartaric, boric, hydrochloric, nitric, phosphoric, sulfuric, and combinations thereof or derivatives/substituted variants thereof. In some embodiments, either ascorbic, citric, lactic, or nicotinic acids may be used.

Additionally, the ester hydrolysis catalysts may, in some embodiments, include acids that are a combination of a weak organic acid and a compound that may be hydrolyzed to a strong acid. In this combination, the weak organic acid may hydrolyze the compound, liberating the stronger acid, and the strong acid may hydrolyze the cellulose ester. Weak organic acids may, in some embodiments, include: ascorbic acid, citric acid, lactic acid, nicotinic acid, hydroxysuccinic acid, and combinations thereof. Compounds that may be hydrolyzed to provide a strong acid may, in some embodiments, include: cellulose sulfate, dodecyl sulfate, ascorbyl-2-sulfate, ascorbyl-2-phosphate, phosphorus pentoxide, phosphorus pentoxide based esters, cellulose nitrate, 2-ethyl hexyl phosphate, and combinations and/or derivatives thereof.

In some embodiments, acid salts may include, without limitation, metal salts where the metal is selected from the group consisting of aluminum, potassium, sodium, and zinc, with corresponding counterions selected from the group consisting of nitrates, dihydrogen phosphates, hydrogen phosphates, phosphates hydrogen sulfates, sulfates, and combinations thereof. Also included as an acid salt are alum (aluminum potassium sulfate) and aluminum ammonium sulfate. In some embodiments, either sodium hydrogen sulfate (NaHSO₄) or sodium dihydrogen phosphate (NaH₂PO₄) is used.

In some embodiments, an ester hydrolysis catalyst that is a base may include, without limitation, metal hydroxides, calcium oxide (lime), urea, borax, sodium metasilicate, ammonium hydroxide, sodium carbonate, sodium phosphate tribasic, sodium hypochlorite, sodium hydrogen carbonate (sodium bicarbonate), and combinations thereof.

In some embodiments, bacteria may be those bacteria that produce an acid, bacteria that attack and degrade cellulose esters directly, or combinations of such bacteria. Bacteria that produce acids are typically provided with a food source. Thus, when this bacterium is released, by dissolving action of water, the bacterium digests the food source, produces a weak acid, and the weak acid catalyzes the hydrolysis of the cellulose ester. In some embodiments, a bacterium that may produce an acid includes, without limitation, lactobacillus acidophilus, bifidobacterium longum, acetobacterium woodii, acetobacter aceti (vinegar bacteria), and combinations thereof. The food sources for these bacteria are conventional and may include lactose, glucose, and/or triactin based materials. Bacteria that attacks and degrades cellulose esters directly do not require the food source. In some embodiments such bacteria include, without limitation, rhizobium meliloti, alcaligenes xylosoxidans, and combinations thereof.

The amount of ester hydrolysis catalyst present in the capsules of the invention should be sufficient to cause degradation of the cellulose ester consumable product at a rate faster than an equivalent untreated product. For example, in some embodiments, the time for degradation may be in a range from about 2 months to about 6 months. The amount of the catalyst may depend upon, for example, the weight of the cellulose ester in the consumable product, the desired time for degradation of the consumable product, and the exact ester hydrolysis catalyst chosen.

For example, if an acid is chosen and the target time for degradation is in a range from about 2 months to about 6 months, then, in some embodiments, the amount of acid may be in a range from about 2% to about 200% by weight of the cellulose ester in the consumable product, including any nested range inbetween. In another embodiment, using the same desired outcomes as above, the amount of acid may be in a range from about 5% to about 100% by weight of the cellulose ester, including any nested range inbetween. In yet another embodiment, the amount of acid may be in a range from about 10% to about 50% by weight of the cellulose acetate, including any nested range inbetween.

In some embodiments, where the ester hydrolysis catalyst is a base, a target time for degradation may be in a range from about 2 months to about 6 months, with an amount of base in a range of from about 50% to about 500% by weight of the cellulose ester in the consumable product, including any nested range inbetween. In other embodiments, using the same desired outcomes as above, the amount of base may be in a range from about 80% to about 300% by weight of the cellulose ester, including any nested range inbetween. In yet other embodiment, the amount of base may be in a range from about 100% to about 200% by weight of the cellulose ester, including any nested range inbetween.

In some embodiments, where bacteria are chosen and the target time for degradation is in a range from about 2 months to about 6 months, the amount of bacteria may be in a range from about 1 to about a billion colony forming units (cfu), including from about 100 cfu to about 100,000,000 cfu, from about 1,000 cfu to about 10,000,000 cfu, from about 10,000 cfu to about 1,000,00 cfu, or any nested ranges therebetween, in conjunction with any required nutrients. The number of colony forming units may be about 1 cfu, 100 cfu, 1,000 cfu, about 10,000 cfu, about 100,000 cfu, about 1,000,000 cfu, about 10,000,000 cfu, about 100,000,000 cfu, and about 1,000,000,000 cfu, including any value inbetween or fractions thereof.

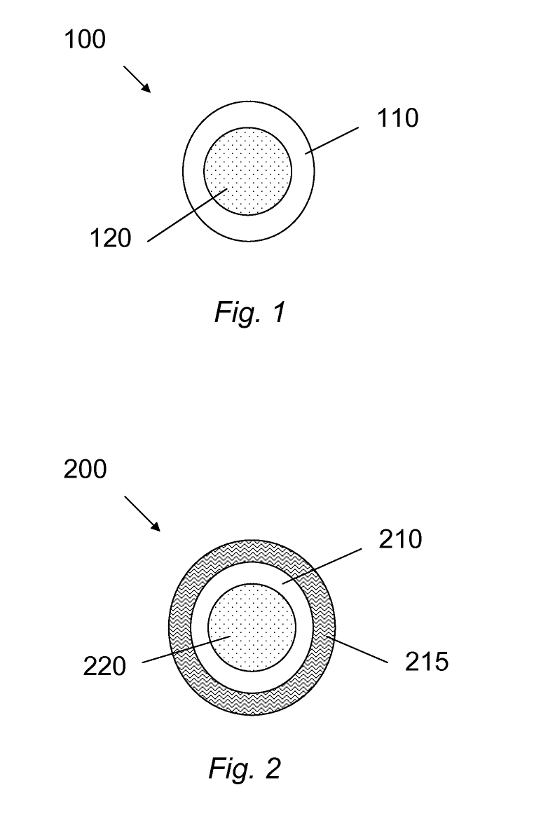

In some embodiments, at least one water permeable coating is disposed substantially about the capsule, including partially coating and completely coating the capsule. As described herein, the coating may be of any type that modulates the release of the ester hydrolysis catalyst. For example, capsules may be completely coated or may be porous. In some embodiments, capsules may be completely coated with one or more layers and holes introduced in one or more layers to modulate release. For example, modulated release tablets can be formed by use of a pin drill or the like to introduce holes in any pattern through a coated capsule. Referring now to FIG. 1, a malleable capsule of the invention 100 is shown having a water permeable coating 110, about a capsule 120. Capsule 120 is the center of malleable capsule 100. Capsule 120 comprises the flexible polymer, any plasticizer, and the ester hydrolysis catalyst. In some embodiments, water permeable coating 110 may comprise cellulosic ethers such as methyl cellulose, ethyl cellulose, carboxy methyl cellulose, hydroxypropyl cellulose, hydroxyethyl cellulose, and hydroxy propylmethyl cellulose, or mixtures and/or derivatives thereof. In some embodiments, water permeable coatings having modified release characteristics may include, without limitation, polysaccharide based polymers, cellulose acetate phthalate, polyvinylacetate phthalate, methylcellulose phthalate, ethylhydroxycellulose phthalate, hydroxypropylmethyl cellulose phthalate, cellulose acetate succinate, acetate trimellitate, polyvinyl butyrate acetate, vinyl acetate-maleic anhydride copolymer, styrene-maleic mono-ester copolymer, ethylcellulose, a cellulose ester, shellac, polyvinyl alcohol, sodium alginate, methyl acrylate-methacrylic acid copolymer, methacrylate-methacrylic acid-octyl acrylate copolymer, or shellac, or mixtures and/or derivatives thereof. In some embodiments, the selection of water permeable coating is also selected to be biodegradable as described herein.

In some embodiments, capsules of the invention may have coatings that are multilayered, such multilayered coatings substantially coating the entirety of the capsules or partially coating the capsules as described above. Referring now to FIG. 2, there is shown a malleable capsule 200 having a two-layer coating comprising an inner layer 210 and outer layer 215 each circumferentially disposed about capsule 220. While FIG. 2 shows two layers, one skilled in the art will recognize that a multilayered coating may employ 2, 3, 4, 5, or even 6 coatings, although as processing becomes more complex with a high number of layers, a practical limit in cost and/or processing time may be reached at the higher end. Other coatings employed in the art include those having a porous structure. The porous structure may be the natural structure of the material, or alternatively pores of controlled dimensions may be introduced into the coating, for example by drilling.

Referring back to FIG. 2, capsules of the invention may, in some embodiments, employ an inner layer 210 comprising ethylcellulose. In some embodiments, inner layer 210 may comprise hydroxypropylmethyl cellulose. As used herein, “inner layer” may refer to any intermediate layer disposed between outer layer 215 and capsule 220, where more than a two-layered coating is present. In some embodiments, capsules of the invention have an outer layer 215 comprising cellulose acetate. Any inner layer 210 and/or outer layer 215 may employ coating materials selected from the group consisting of cellulosic ethers such as methyl cellulose, ethyl cellulose, carboxy methyl cellulose, hydroxypropyl cellulose, hydroxyethyl cellulose and hydroxy propylmethyl cellulose, or mixtures and/or derivatives thereof. Any inner layer 210 and/or outer layer 215 may employ a coating material selected from the group consisting of cellulose acetate phthalate, polyvinylacetate phthalate, methylcellulose phthalate, ethylhydroxycellulose phthalate, hydroxypropylmethyl cellulose phthalate, cellulose acetate succinate, acetate trimellitate, polyvinyl butyrate acetate, vinyl acetate-maleic anhydride copolymer, styrene-maleic mono-ester copolymer, ethylcellulose, a cellulose ester, shellac, polyvinyl alcohol, sodium alginate, methyl acrylate-methacrylic acid copolymer, methacrylate-methacrylic acid-octyl acrylate copolymer, shellac, cellulose acetate, cellulose triacetate, cellulose nitrate, cellulose sulfate, sodium salt, and cellulose phosphate, or mixtures and/or derivatives thereof.

In some embodiments, capsules of the invention may further comprise a flavorant. In some such embodiments, the flavorant may be used in a consumable product that includes a filter, such as a cigarette. In some embodiments, the flavorant is selected from the group consisting of tobacco, clove, ground clove, ground clove flower, cocoa, menthol, cherry, chocolate, orange, mint, mango, vanilla, cinnamon, anethole, licorice, limonene, citrus, eugenol, and combinations thereof.

In some embodiments, the present invention provides a consumable product comprising a smoking device filter, the filter comprising a malleable capsule disposed within a first section of the smoking device filter, the capsule comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water. In some such embodiments, the capsule is disposed within the cellulose acetate tow of the smoking filter. In some embodiments, multiple capsules are provided within the cellulose acetate tow of the smoking filter.

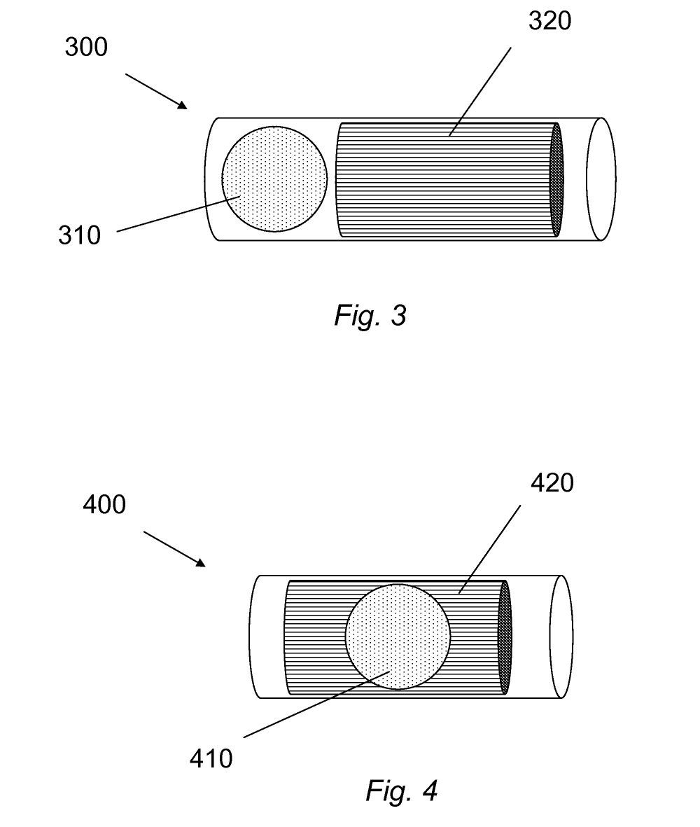

In some embodiments, smoking device filters of the invention further comprise a cellulose acetate tow disposed within a second section of the smoking device filter. Referring now to FIG. 3, there is shown a smoking filter device 300 in accordance with one embodiment of the invention. Smoking filter device 300 includes the malleable capsule 310 comprising the ester hydrolysis catalyst disposed in a first section of the smoking device filter and a cellulose acetate tow 320 disposed in a second section of the smoking device filter. Although not shown physically abutting each other, malleable capsule 310 and cellulose acetate tow 320 may be in intimate contact or there may be a separator (not shown) preventing them from intimate contact. In some embodiments, cellulose acetate tow 320 may be configured with a concave end to conformally accommodate spherical malleable capsule 310.

As shown in FIG. 4, in some embodiments, a smoking device filter 400 of the invention may comprise a cellulose acetate tow 420 disposed within the first section of smoking device filter 400, where the malleable capsule 410 is disposed in the same first section, that is disposed within cellulose acetate tow 420. In some embodiments, whether the malleable capsule is disposed next to the cellulose acetate tow, as in FIG. 3, for within the tow, as in FIG. 4, the smoking device filter may be configured such that crushing of the filter may aid in the distribution of the ester hydrolysis catalyst through the tow material.

In some embodiments, the smoking device filter of the invention further comprises a porous mass comprising an active particle and a binder particle disposed within a second section of the smoking device filter. In some such embodiments, the active particle is capable of reducing or removing a smoke stream component. For example, the active particle may reduce a component comprising one selected from the group consisting of: acetaldehyde, acetamide, acetone, acrolein, acrylamide, acrylonitrile, aflatoxin B-1, 4-aminobiphenyl, 1-aminonaphthalene, 2-aminonaphthalene, ammonia, ammonium salts, anabasine, anatabine, 0-anisidine, arsenic, A-α-C, benz[a]anthracene, benz[b]fluoroanthene, benz[j]aceanthrylene, benz[k]fluoroanthene, benzene, benzo(b)furan, benzo[a]pyrene, benzo[c]phenanthrene, beryllium, 1,3-butadiene, butyraldehyde, cadmium, caffeic acid, carbon monoxide, catechol, chlorinated dioxins/furans, chromium, chrysene, cobalt, coumarin, a cresol, crotonaldehyde, cyclopenta[c,d]pyrene, dibenz(a,h)acridine, dibenz(a,j)acridine, dibenz[a,h]anthracene, dibenzo(c,g)carbazole, dibenzo[a,e]pyrene, dibenzo[a,h]pyrene, dibenzo[a,i]pyrene, dibenzo[a,l]pyrene, 2,6-dimethylaniline, ethyl carbamate (urethane), ethylbenzene, ethylene oxide, eugenol, formaldehyde, furan, glu-P-1, glu-P-2, hydrazine, hydrogen cyanide, hydroquinone, indeno[1,2,3-cd]pyrene, IQ, isoprene, lead, MeA-a-C, mercury, methyl ethyl ketone, 5-methylchrysene, 4-(methylnitrosamino)-1-(3-pyridyl)-1-butanone (NNK), 4-(methylnitrosamino)-1-(3-pyridyl)-1-butanol (NNAL), naphthalene, nickel, nicotine, nitrate, nitric oxide, a nitrogen oxide, nitrite, nitrobenzene, nitromethane, 2-nitropropane, N-nitrosoanabasine (NAB), N-nitrosodiethanolamine (NDELA), N-nitrosodiethylamine, N-nitrosodimethylamine (NDMA), N-nitrosoethylmethylamine, N-nitrosomorpholine (NMOR), N-nitrosonornicotine (NNN), N-nitrosopiperidine (NPIP), N-nitrosopyrrolidine (NPYR), N-nitrososarcosine (NSAR), phenol, PhIP, polonium-210 (radio-isotope), propionaldehyde, propylene oxide, pyridine, quinoline, resorcinol, selenium, styrene, tar, 2-toluidine, toluene, Trp-P-1, Trp-P-2, uranium-235 (radio-isotope), uranium-238 (radio-isotope), vinyl acetate, vinyl chloride, and any combinations thereof.

In some embodiments, the smoking device of the invention may include an active particle that comprises one selected from the group consisting of a nano-scaled carbon particle, a carbon nanotube having at least one wall, a carbon nanohorn, a bamboo-like carbon nanostructure, a fullerene, a fullerene aggregate, graphene, a few layer graphene, oxidized graphene, an iron oxide nanoparticle, a nanoparticle, a metal nanoparticle, a gold nanoparticle, a silver nanoparticle, a metal oxide nanoparticle, an alumina nanoparticle, a magnetic nanoparticle, a paramagnetic nanoparticle, a superparamagnetic nanoparticle, a gadolinium oxide nanoparticle, a hematite nanoparticle, a magnetite nanoparticle, a gado-nanotube, an endofullerene, Gd@C60, a core-shell nanoparticle, an onionated nanoparticle, a nanoshell, an onionated iron oxide nanoparticle, and combinations thereof.

In some embodiments, the smoke device filter of the invention may include an additive that comprises one selected from the group consisting of activated carbon, an ion exchange resin, a desiccant, a silicate, a molecular sieve, a silica gel, activated alumina, a zeolite, perlite, sepiolite, Fuller's Earth, magnesium silicate, a metal oxide, iron oxide, activated carbon, a nanoparticle, and combinations thereof.

In some embodiments, the smoking device filter of the invention includes a binder particle that comprises one selected from the group consisting of ultrahigh molecular weight polyethylene, very high molecular weight polyethylene, high molecular weight polyethylene, a polyolefin, a polyester, a polyamide, a nylon, a polyacrylic, a polystyrene, a polyvinyl, polytetrafluoroethylene, polyether ether ketone, a non-fibrous plasticized cellulose, polyethylene, polypropylene, polybutylene, polymethylpentene, low-density polyethylene, linear low-density polyethylene, high-density polyethylene, polyethylene terephthalate, polybutylene terephthalate, polycyclohexylene dimethylene terephthalate, polytrimethylene terephthalate, polyacrylics, polymethyl methacrylate, polystyrene, acrylonitrile-butadiene-styrene, styrene-acrylonitrile, styrene-butadiene, styrene-maleic anhydride, ethylene vinyl acetate, ethylene vinyl alcohol, polyvinyl chloride, cellulose acetate, cellulose acetate butyrate, plasticized cellulosics, cellulose propionate, ethyl cellulose, any derivative thereof, any copolymer thereof, and combinations thereof.

In some embodiments, the smoking device filter of the invention further comprises a filter component disposed within a second section of the smoking device filter, the filter component selected from the group consisting of cellulose acetate, polypropylene, polyethylene, polyolefin tow, polypropylene tow, polyethylene terephthalate, polybutylene terephthalate, random oriented acetate, a paper, a corrugated paper, a concentric filter, a peripheral filter of fibrous tow and a core of a web material, carbon-on-tow, a Dalmatian filter, silica, magnesium silicate, a zeolite, a molecular sieve, a salt, a catalyst, sodium chloride, nylon, a flavorant, tobacco, cellulose, a cellulosic derivative, a catalytic converter, iodine pentoxide, a coarse powder, a carbon particle, a carbon fiber, a fiber, a glass bead, a void chamber, a menthol capsule, a baffled void chamber, and combinations thereof.

In some embodiments, the smoking device filter of the invention further comprises an additive comprising one selected from the group consisting of an ionic resin, a zeolite, a nanoparticle, a ceramic particle, a softening agent, a plasticizer, a pigment, a dye, a flavorant, an aroma, a controlled-release vesicle, a binder, an adhesive, a tackifier, a surface modification agent, a lubricating agent, an emulsifier, a vitamin, a peroxide, a biocide, an antifungal, an antimicrobial, an antistatic agent, a flame retardant, an antifoaming agent, a degradation agent, and combinations thereof.

In some embodiments, achieving filters that comprise an additive may be by including the additives in the dope; by applying the additives to the filaments before, after, and/or during formation of a tow band; by applying the additives to the filaments before, after, and/or during crimping the tow band; by applying the additives to the filaments before, after, and/or during conditioning the crimped tow band; and any combination thereof. It should be noted that applying includes, but is not limited to, dipping, immersing, submerging, soaking, rinsing, washing, painting, coating, showering, drizzling, spraying, placing, dusting, sprinkling, affixing, and any combination thereof. Further, it should be noted that applying includes, but is not limited to, surface treatments, infusion treatments where the additive incorporates at least partially into the filament, and any combination thereof.

One skilled in the art with the benefit of this disclosure should understand the concentration of the additive will depend at least on the composition of the additive, the size of the additive, the purpose of the additive, the point in the process in which the additive is included, and the size of the filament. By way of nonlimiting example, additives may be present in the dope in an amount ranging from about 0.01% to about 10% by weight of the polymer. By way of another nonlimiting example, additives that comprise particulates may be included such that the filament comprises about 0.01% to about 10% by volume of the filament.

Suitable active particles may include, but not be limited to, nano-scaled carbon particles, carbon nanotubes having at least one wall, carbon nanohorns, bamboo-like carbon nanostructures, fullerenes, fullerene aggregates, graphene, few layer graphene, oxidized graphene, iron oxide nanoparticles, nanoparticles, metal nanoparticles, gold nanoparticles, silver nanoparticles, metal oxide nanoparticles, an alumina nanoparticle, a magnetic nanoparticle, paramagnetic nanoparticle, a superparamagnetic nanoparticle, a gadolinium oxide nanoparticle, a hematite nanoparticle, a magnetite nanoparticle, a gado-nanotube, an endofullerene, Gd@C60, a core-shell nanoparticle, an onionated nanoparticle, a nanoshell, an onionated iron oxide nanoparticle, activated carbon, an ion exchange resin, a desiccant, a silicate, a molecular sieve, a silica gel, activated alumina, a zeolite, perlite, sepiolite, Fuller's Earth, magnesium silicate, a metal oxide, iron oxide, activated carbon, and any combination thereof.

Suitable active particles may have at least one dimension of about less than one nanometer, such as graphene, to as large as a particle having a diameter of about 5000 microns. Active particles may range from a lower size limit in at least one dimension of about: 0.1 nanometers, 0.5 nanometers, 1 nanometer, 10 nanometers, 100 nanometers, 500 nanometers, 1 micron, 5 microns, 10 microns, 50 microns, 100 microns, 150 microns, 200 microns, and 250 microns. The active particles may range from an upper size limit in at least one dimension of about: 5000 microns, 2000 microns, 1000 microns, 900 microns, 700 microns, 500 microns, 400 microns, 300 microns, 250 microns, 200 microns, 150 microns, 100 microns, 50 microns, 10 microns, and 500 nanometers. Any combination of lower limits and upper limits above may be suitable for use in the present invention, wherein the selected maximum size is greater than the selected minimum size. In some embodiments, the active particles may be a mixture of particle sizes ranging from the above lower and upper limits. In some embodiments, the size of the active particles may be polymodal.

Suitable active compounds may include, but not be limited to, malic acid, potassium carbonate, citric acid, tartaric acid, lactic acid, ascorbic acid, polyethyleneimine, cyclodextrin, sodium hydroxide, sulphamic acid, sodium sulphamate, polyvinyl acetate, carboxylated acrylate, and any combination thereof.

Suitable ionic resins may include, but not be limited to, polymers with a backbone, such as styrene-divinyl benezene (DVB) copolymer, acrylates, methacrylates, phenol formaldehyde condensates, and epichlorohydrin amine condensates; a plurality of electrically charged functional groups attached to the polymer backbone; and any combination thereof.

Zeolites may include crystalline aluminosilicates having pores, e.g., channels, or cavities of uniform, molecular-sized dimensions. Zeolites may include natural and synthetic materials. Suitable zeolites may include, but not be limited to, zeolite BETA (Na₇(Al₇Si₅₇O₁₂₈) tetragonal), zeolite ZSM-5 (Naₙ(AlₙSi₉₆₋ₙO₁₉₂) 16 H₂O, with n<27), zeolite A, zeolite X, zeolite Y, zeolite K-G, zeolite ZK-5, zeolite ZK-4, mesoporous silicates, SBA-15, MCM-41, MCM48 modified by 3-aminopropylsilyl groups, alumino-phosphates, mesoporous aluminosilicates, other related porous materials (e.g., such as mixed oxide gels), or any combination thereof.

Suitable nanoparticles may include, but not be limited to, nano-scaled carbon particles like carbon nanotubes of any number of walls, carbon nanohorns, bamboo-like carbon nanostructures, fullerenes and fullerene aggregates, and graphene including few layer graphene and oxidized graphene; metal nanoparticles like gold and silver; metal oxide nanoparticles like alumina, silica, and titania; magnetic, paramagnetic, and superparamagnetic nanoparticles like gadolinium oxide, various crystal structures of iron oxide like hematite and magnetite, about 12 nm Fe₃O₄, gado-nanotubes, and endofullerenes like Gd@C₆₀; and core-shell and onionated nanoparticles like gold and silver nanoshells, onionated iron oxide, and others nanoparticles or microparticles with an outer shell of any of said materials; or any combination of the foregoing (including activated carbon). It should be noted that nanoparticles may include nanorods, nanospheres, nanorices, nanowires, nanostars (like nanotripods and nanotetrapods), hollow nanostructures, hybrid nanostructures that are two or more nanoparticles connected as one, and non-nano particles with nano-coatings or nano-thick walls. It should be further noted that nanoparticles may include the functionalized derivatives of nanoparticles including, but not limited to, nanoparticles that have been functionalized covalently and/or non-covalently, e.g., pi-stacking, physisorption, ionic association, van der Waals association, and the like. Suitable functional groups may include, but not be limited to, moieties comprising amines (1°, 2°, or 3°), amides, carboxylic acids, aldehydes, ketones, ethers, esters, peroxides, silyls, organosilanes, hydrocarbons, aromatic hydrocarbons, and any combination thereof; polymers; chelating agents like ethylenediamine tetraacetate, diethylenetriaminepentaacetic acid, triglycollamic acid, and a structure comprising a pyrrole ring; and any combination thereof. Functional groups may enhance removal of smoke components and/or enhance incorporation of nanoparticles into a porous mass.

Suitable softening agents and/or plasticizers may include, but not be limited to, water, glycerol triacetate(triacetin), triethyl citrate, dimethoxy-ethyl phthalate, dimethyl phthalate, diethyl phthalate, methyl phthalyl ethyl glycolate, o-phenyl phenyl-(bis)phenyl phosphate, 1,4-butanediol diacetate, diacetate, dipropionate ester of triethylene glycol, dibutyrate ester of triethylene glycol, dimethoxyethyl phthalate, triethyl citrate, triacetyl glycerin, and the like, any derivative thereof, and any combination thereof. One skilled in the art with the benefit of this disclosure should understand the concentration of plasticizers to use as an additive to the filaments. By way of non-limiting example, the plasticizer may be added to the dope in an amount sufficient to prevent rupture or bursting of the filament surface upon sudden thermal discharge of the adsorbed solvent.

As used herein, pigments refer to compounds and/or particles that impart color and are incorporated throughout the filaments. Suitable pigments may include, but not be limited to, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, or any combination thereof.

As used herein, dyes refer to compounds and/or particles that impart color and are a surface treatment of the filaments. Suitable dyes may include, but not be limited to, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L).

Suitable flavorants may be any flavorant suitable for use in smoking device filters including those that impart a taste and/or a flavor to the smoke stream. Suitable flavorants may include, but not be limited to, organic material (or naturally flavored particles), carriers for natural flavors, carriers for artificial flavors, and any combination thereof. Organic materials (or naturally flavored particles) include, but are not limited to, tobacco, cloves (e.g., ground cloves and clove flowers), cocoa, and the like. Natural and artificial flavors may include, but are not limited to, menthol, cloves, cherry, chocolate, orange, mint, mango, vanilla, cinnamon, tobacco, and the like. Such flavors may be provided by menthol, anethole (licorice), anisole, limonene (citrus), eugenol (clove), and the like, or any combination thereof. In some embodiments, more than one flavorant may be used including any combination of the flavorants provided herein. These flavorants may be placed in the tobacco column or in a section of a filter. Additionally, in some embodiments, the porous masses of the present invention may comprise a flavorant. The amount to include will depend on the desired level of flavor in the smoke taking into account all filter sections, the length of the smoking device, the type of smoking device, the diameter of the smoking device, as well as other factors known to those of skill in the art.

Suitable aromas may include, but not be limited to, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, cinnamaldehyde, ethyl maltol, vanilla, anisole, anethole, estragole, thymol, furaneol, methanol, or any combination thereof.

Suitable binders may include, but not be limited to, polyolefins, polyesters, polyamides (or nylons), polyacrylics, polystyrenes, polyvinyls, polytetrafluoroethylene (PTFE), polyether ether ketone (PEEK), any copolymer thereof, any derivative thereof, and any combination thereof. Non-fibrous plasticized cellulose derivatives may also be suitable for use as binder particles in the present invention. Examples of suitable polyolefins may include, but not be limited to, polyethylene, polypropylene, polybutylene, polymethylpentene, and the like, any copolymer thereof, any derivative thereof, and any combination thereof. Examples of suitable polyethylenes may include, but not be limited to, ultrahigh molecular weight polyethylene, very high molecular weight polyethylene, high molecular weight polyethylene, low-density polyethylene, linear low-density polyethylene, high-density polyethylene, and the like, any copolymer thereof, any derivative thereof, and any combination thereof. Examples of suitable polyesters may include, but not be limited to, polyethylene terephthalate, polybutylene terephthalate, polycyclohexylene dimethylene terephthalate, polytrimethylene terephthalate, and the like, any copolymer thereof, any derivative thereof, and any combination thereof. Examples of suitable polyacrylics may include, but not be limited to, polymethyl methacrylate, and the like, any copolymer thereof, any derivative thereof, and any combination thereof. Examples of suitable polystyrenes may include, but not be limited to, polystyrene, acrylonitrile-butadiene-styrene, styrene-acrylonitrile, styrene-butadiene, styrene-maleic anhydride, and the like, any copolymer thereof, any derivative thereof, and any combination thereof. Examples of suitable polyvinyls may include, but not be limited to, ethylene vinyl acetate, ethylene vinyl alcohol, polyvinyl chloride, and the like, any copolymer thereof, any derivative thereof, and any combination thereof. Examples of suitable cellulosics may include, but not be limited to, cellulose acetate, cellulose acetate butyrate, plasticized cellulosics, cellulose propionate, ethyl cellulose, and the like, any copolymer thereof, any derivative thereof, and any combination thereof. In some embodiments, binder particles may comprise any copolymer, any derivative, or any combination of the above listed binders. Further, binder particles may be impregnated with and/or coated with any combination of additives disclosed herein.

Suitable tackifiers may include, but not be limited to, methylcellulose, ethylcellulose, hydroxyethylcellulose, carboxy methylcellulose, carboxy ethylcellulose, water soluble cellulose acetate, amides, diamines, polyesters, polycarbonates, silyl-modified polyamide compounds, polycarbamates, urethanes, natural resins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl)quaternary amines, p-T-amyl-phenols condensed with formaldehyde, dialkyl amino alkyl(meth)acrylates, acrylamides, N-(dialkyl amino alkyl) acrylamide, methacrylamides, hydroxy alkyl(meth)acrylates, methacrylic acids, acrylic acids, hydroxyethyl acrylates, and the like, any derivative thereof, or any combination thereof.

Suitable lubricating agents may include, but not be limited to, ethoxylated fatty acids (e.g., the reaction product of ethylene oxide with pelargonic acid to form poly(ethylene glycol) (“PEG”) monopelargonate; the reaction product of ethylene oxide with coconut fatty acids to form PEG monolaurate), and the like, or any combination thereof. The lubricant agents may also be selected from non-water soluble materials such as synthetic hydrocarbon oils, alkyl esters (e.g., tridecyl stearate which is the reaction product of tridecyl alcohol and stearic acid), polyol esters (e.g., trimethylol propane tripelargonate and pentaerythritol tetrapelargonate), and the like, or any combination thereof.

Suitable emulsifiers may include, but not be limited to, sorbitan monolaurate, e.g., SPAN® 20 (available from Uniqema, Wilmington, Del.), poly(ethylene oxide) sorbitan monolaurate, e.g., TWEEN® 20 (available from Uniqema, Wilmington, Del.).

Suitable vitamins may include, but not be limited to, vitamin A, vitamin B1, vitamin B2, vitamin C, vitamin D, vitamin E, or any combination thereof.

Suitable antimicrobials may include, but not be limited to, anti-microbial metal ions, chlorhexidine, chlorhexidine salt, triclosan, polymoxin, tetracycline, amino glycoside (e.g., gentamicin), rifampicin, bacitracin, erythromycin, neomycin, chloramphenicol, miconazole, quinolone, penicillin, nonoxynol 9, fusidic acid, cephalosporin, mupirocin, metronidazolea secropin, protegrin, bacteriolcin, defensin, nitrofurazone, mafenide, acyclovir, vanocmycin, clindamycin, lincomycin, sulfonamide, norfloxacin, pefloxacin, nalidizic acid, oxalic acid, enoxacin acid, ciprofloxacin, polyhexamethylene biguanide (PHMB), PHMB derivatives (e.g., biodegradable biguanides like polyethylene hexaniethylene biguanide (PEHMB)), clilorhexidine gluconate, chlorohexidine hydrochloride, ethylenediaminetetraacetic acid (EDTA), EDTA derivatives (e.g., disodium EDTA or tetrasodium EDTA), and the like, and any combination thereof.

Antistatic agents may comprise any suitable anionic, cationic, amphoteric or nonionic antistatic agent. Anionic antistatic agents may generally include, but not be limited to, alkali sulfates, alkali phosphates, phosphate esters of alcohols, phosphate esters of ethoxylated alcohols, or any combination thereof.

Examples may include, but not be limited to, alkali neutralized phosphate ester (e.g., TRYFAC® 5559 or TRYFRAC® 5576, available from Henkel Corporation, Mauldin, S.C.). Cationic antistatic agents may generally include, but not be limited to, quaternary ammonium salts and imidazolines which possess a positive charge. Examples of nonionics include the poly(oxyalkylene) derivatives, e.g., ethoxylated fatty acids like EMEREST® 2650 (an ethoxylated fatty acid, available from Henkel Corporation, Mauldin, S.C.), ethoxylated fatty alcohols like TRYCOL® 5964 (an ethoxylated lauryl alcohol, available from Henkel Corporation, Mauldin, S.C.), ethoxylated fatty amines like TRYMEEN® 6606 (an ethoxylated tallow amine, available from Henkel Corporation, Mauldin, S.C.), alkanolamides like EMID® 6545 (an oleic diethanolamine, available from Henkel Corporation, Mauldin, S.C.), or any combination thereof. Anionic and cationic materials tend to be more effective a ntistats.

In some embodiments, the present invention provides a smoking device comprising a smoking device filter comprising a malleable capsule disposed within a first section of the smoking device filter, the capsule comprising: (a) a flexible polymer; (b) a plasticizer; (c) an ester hydrolysis catalyst disposed within the capsule; wherein a portion of the catalyst is released from the capsule upon exposure of the capsule to water; and (d) at least one water permeable coating disposed about the capsule; wherein the smoking device further comprises a housing capable of maintaining a smokeable substance in fluid contact with the smoking device filter.

In some embodiments, the smoking device of the invention includes a housing comprising at least one selected from the group consisting of a cigarette, a cigarette holder, a cigar, a cigar holder, a pipe, a water pipe, a hookah, an electronic smoking device, a roll-your-own cigarette, a roll-your-own cigar, and a paper.

In some embodiments, the smoking device of the invention includes a smoking device filter having a diameter from about 0.5 mm to about 10 mm and a length from about 5 mm to about 35 mm.

In some embodiments, the smoking device of the invention includes a paper comprising at least one selected from the group consisting of a wood-based paper, a paper having flax, a flax paper, a functionalized paper, a marking paper, a colorized paper, a high porosity paper, a corrugated paper, a high surface strength paper, and any combination thereof.

In some embodiments, the smoking device of the invention includes paper further comprising a paper component comprising at least one selected from the group consisting of an additive, a sizing, a printability agent, and combinations thereof.

In some embodiments, the smoking device of the invention includes a smokeable substance comprising at least one tobacco selected from the group consisting of tobacco, bright leaf tobacco, burley tobacco, Oriental tobacco (also known as Turkish tobacco), Cavendish tobacco, corojo tobacco, criollo tobacco, Perique tobacco, shade tobacco, white burley tobacco, and combinations thereof. In some embodiments, the smoking device of the invention includes a smokeable substance in the form of a tobacco column. In some such embodiments, the tobacco column comprises a bendable element.

In some embodiments, the smoking device of the invention includes a tobacco column comprising at least one selected from the group consisting of tobacco, sugar, sucrose, brown sugar, invert sugar, high fructose corn syrup, propylene glycol, glycerol, cocoa, a cocoa product, a carob bean gum, a carob bean extract, a flavorant, menthol, licorice extract, diammonium phosphate, ammonium hydroxide, and any combination thereof.

In some embodiments, the smoking device of the invention comprises a filter that is removable, replaceable, disposable, recyclable, and/or degradable. In some such embodiments, a degradable filter includes the smoking device filter as described above.

In some embodiments, the present invention provides packs of filters comprising: packs comprising at least a plurality of filters, the filters comprising at least one malleable capsule disposed within a first section of the filter, the capsules comprising: (a) flexible polymers; (b) plasticizers; (c) at least one ester hydrolysis catalyst disposed within the capsules; and (d) at least one water permeable coating disposed about each capsule, wherein a portion of the catalyst is released from the capsules upon exposure of the capsules to water.

In some such embodiments, the pack of filters may have filters further comprising at least one selected from the group consisting of: active particles, active compounds, ionic resins, zeolites, nanoparticles, ceramic particles, softening agents, plasticizers, pigments, dyes, flavorants, aromas, controlled release vesicles, binders, adhesives, tackifiers, surface modification agents, lubricating agents, emulsifiers, vitamins, peroxides, biocides, antifungals, antimicrobials, antistatic agents, flame retardants, antifoaming agents, degradation agents, conductivity modifying agents, stabilizing agents, and any combination thereof.

In some embodiments, the packs of filters include packs selected from the group consisting of: a hinge-lid pack, a slide-and-shell pack, a hard cup pack, a soft cup pack, and any combination thereof. In some embodiments, the packs can include a polypropylene wrapper. In some such embodiments, the polypropylene wrapper comprises a tear tab.

In some embodiments, the present invention provides packs of smoking devices comprising: packs comprising at least one smoking device that comprises a filter, the filter comprising at least one malleable capsule disposed within a first section of the filter, such capsules comprising: (a) flexible polymers; (b) plasticizers; (c) at least one ester hydrolysis catalyst disposed within the capsules; and (d) at least one water permeable coating disposed about the capsules, wherein a portion of the catalyst is released from the capsule upon exposure of the capsule to water. In some embodiments, packs of smoking devices of the invention may include devices wherein the filter has a circumference of about 26 mm or less.

In some embodiments, the packs of smoking devices of the invention include packs selected from the group consisting of: a hinge-lid pack, a slide-and-shell pack, a hard cup pack, a soft cup pack, and any combination thereof. In some embodiments, such packs may further comprise a polypropylene wrapper. In some such embodiments, the polypropylene wrapper comprises a tear tab.

In some embodiments, packs of smoking devices of the invention include smoking devices selected from the group consisting of: a cigarette and a cigar. In some such embodiments, the smoking devices may be sealed as a bundle inside the pack, wherein the bundle comprises at least one smoking device.

In some embodiments, the present invention provides cartons of smoking device packs comprising, the carton comprising at least one pack, the packs comprising at least one smoking device that comprises a filter, the filters comprising at least one malleable capsule disposed within a first section of the filter, the capsules comprising: (a) flexible polymers; (b) plasticizers; (c) at least one ester hydrolysis catalyst disposed within the capsules; and (d) at least one water permeable coating disposed about the capsules, wherein a portion of the catalyst is released from the capsules upon exposure of the capsules to water.

In some embodiments, the cartons of smoking device packs of the invention may be configured for sufficient physical integrity to contain the weight of the packs of smoking devices.

In some embodiments, cartons of smoking device packs of the invention may include a polypropylene wrapper. In some such embodiments, the polypropylene wrapper may comprise a tear tab.

In some embodiments, cartons of smoking device packs of the invention may include smoking devices selected from the group consisting of: a cigarette and a cigar. In some embodiments, cartons of smoking device packs of the invention may include the smoking devices sealed as a bundle inside the pack, wherein the bundle comprises at least one smoking device.

In some embodiments, the present invention provides a method of smoking a smoking device, the method comprising heating or lighting a smoking device to form smoke, wherein the smoking device comprises at least one filter section comprising at least one malleable capsule disposed within a first section of the filter, the capsules comprising: (a) flexible polymers; (b) plasticizers; (c) at least one ester hydrolysis catalyst disposed within the capsule; and (d) at least one water permeable coating disposed about the capsule, wherein a portion of the catalyst is released from the capsules upon exposure of the capsules to water; and drawing the smoke through the smoking device.

In some embodiments, the present invention provides methods for making a filter rod, such methods comprising: providing a first filter section; and disposing at least one malleable capsule within the first filter section, the capsules comprising: (a) a flexible polymer; (b) a plasticizer; (c) an ester hydrolysis catalyst disposed within the capsule; and (d) at least one water permeable coating disposed about the capsule, wherein a portion of the catalyst is released from the capsule upon exposure of the capsule to water.

In some embodiments, methods of the invention may further comprise joining a second filter section to the first filter section.

In some embodiments, methods of the invention may include filter rods with the first, second, or both filter sections further comprising at least one selected from the group consisting of: cavities, porous masses, polypropylenes, polyethylenes, polyolefin tows, polypropylene tows, polyethylene terephthalates, polybutylene terephthalates, random oriented acetates, papers, corrugated papers, concentric filters, carbon-on-tows, silica, magnesium silicate, zeolites, molecular sieves, salts, catalysts, sodium chloride, nylon, flavorants, tobacco, capsules, cellulose, cellulosic derivatives, cellulose acetate, catalytic converters, iodine pentoxide, coarse powders, carbon particles, carbon fibers, fibers, glass beads, nanoparticles, void chambers, baffled void chambers, cellulose acetate tows with less than about 10 denier per filament, and any combination thereof.

In some embodiments, the present invention provides methods of making smoking devices, the methods comprising: providing filter rods comprising at least one filter section that comprises at least one malleable capsule disposed within a first section of the filter, the capsules comprising: (a) flexible polymers; (b) plasticizers; (c) at least one ester hydrolysis catalyst disposed within the capsule; and (d) at least one water permeable coating disposed about the capsule, wherein a portion of the catalyst is released from the capsule upon exposure of the capsule to water, providing a tobacco column, cutting the filter rod transverse to its longitudinal axis through the center of the rod to form at least two smoking device filters having at least one filter section that comprises a porous mass that comprises an active particle and a binder particle; and joining at least one of the smoking device filters to the tobacco column along the longitudinal axis of the filter and the longitudinal axis of the tobacco column to form at least one smoking device.

In some such methods the filter rod may have a length ranging from about 80 mm to about 150 mm, including about 80 mm, about 90 mm, about 100 mm, about 110 mm, about 120 mm, about 130 mm, about 140 mm, and about 150 mm, including any value inbetween and fractions thereof. In some such embodiments, the filter rod may be cut into about 4 to about 6 filter sections of about 5 mm to about 35 mm in length, including about 5 mm about 10 mm about 15 mm, about 20 mm, about 25 mm, about 30 mm and about 35 mm, including any value inbetween and fractions thereof. In some embodiments, the filter sections need not be of equal length. In some embodiments, the filter sections can be cut of equal length.

In some embodiments, the present invention provides methods of making a smoking device, the methods comprising: providing a tobacco column;

and joining a filter to the tobacco column, wherein the filter comprises at least one malleable capsule disposed within a first section of the filter, the capsules comprising: (a) flexible polymers; (b) plasticizers; (c) at least one ester hydrolysis catalyst disposed within the capsule; and (d) at least one water permeable coating disposed about the capsules, wherein a portion of the catalyst is released from the capsules upon exposure of the capsules to water.

Some embodiments may involve adhering the paper of a wrapped tow rod yielding a filter rod length. Adhering may be achieved with any known adhesive capable of adhesively securing the paper wrapped about the tow rod.

Some embodiments may involve cutting the filter rod length into filter rods and/or filter sections. Cutting may involve any known method and/or apparatus of cutting. The length of a filter rod may range from a lower limit of about 50 mm, 75 mm, or 100 mm to an upper limit of about 150 mm, 140 mm, 130 mm, 120 mm, 110 mm, or 100 mm, and wherein the length may range from any lower limit to any upper limit and encompass any subset therebetween. The length of a filter may range from a lower limit of about 20 mm, 25 mm, or 30 mm to an upper limit of about 50 mm, 45 mm, or 40 mm, and wherein the length may range from any lower limit to any upper limit and encompass any subset therebetween. The length of a filter section may range from a lower limit of about 3 mm, 4 mm, or 5 mm to an upper limit of about 15 mm, 14 mm, 13 mm, 12 mm, 11 mm, or 10 mm, and wherein the length may range from any lower limit to any upper limit and encompass any subset therebetween.

Some embodiments may involve connecting at least two filter sections. Some embodiments may involve connecting at least two filter sections in fluid communication with each other. Connecting may include, but not be limited to, joining, attaching, combining, associating, coupling, or the like. In some embodiments, connecting may be end-to-end along the longitudinal axis of the filter sections. In some embodiments, connecting at least two filter sections may form a sectioned filter and/or a sectioned filter rod. Some embodiments may involve providing at least two filter sections in respective containers, e.g., hoppers, crates, boxes, drums, bags, or cartons, before connecting. Some embodiments may comprise feeding the at least two filter sections into a row wherein the sections are alternated. Some embodiments may involve wrapping the at least two filter sections with a paper to form a segmented filter and/or a segmented filter rod. Some embodiments may involve transporting the segmented filter and/or the segmented filter rod for storage or use.

In some embodiments, a filter may be a sectioned filter. Some embodiments may involve a sectioned filter where at least one first section is a filter section described herein and at least one second filter section may include, but not be limited to, cavities, porous masses, polypropylene, polyethylene, polyolefin tow, polypropylene tow, polyethylene terephthalate, polybutylene terephthalate, random oriented acetate, papers, corrugated papers, concentric filters, carbon-on-tow, silica, magnesium silicate, zeolites, molecular sieves, salts, catalysts, sodium chloride, nylon, flavorants, tobacco, capsules, cellulose, cellulosic derivatives, cellulose acetate, catalytic converters, iodine pentoxide, coarse powders, carbon particles, carbon fibers, fibers, glass beads, nanoparticles, void chambers, baffled void chambers, or any combination thereof. It should be noted, that first and second are used for clarity in the description and do not imply any order or positional relationship. In some embodiments, the second filter section may be a cellulose acetate filter section having a different EPD than the first filter section. In some embodiments, the first filter section and the second filter section may be different filter sections described herein, e.g., different additives, different additive concentrations, different EPD, different total denier, different dpf, or any combination thereof.

In some embodiments, filter rods, filters, filter sections, sectioned filters, and/or sectioned filter rods may comprise at least one cavity. In some embodiments, a cavity may be between two filter sections. The cavity may be filled with a variety of substances including, but not limited to, additives, granulated carbon, flavorants, catalysts, molecular sieves, zeolites, or any combination thereof. The cavity may contain a capsule, e.g., a polymeric capsule, that itself contains a flavorant or catalyst. The cavity, in some embodiments, may also contain a molecular sieve that reacts with selected components in the smoke to remove or reduce the concentration of the components without adversely affecting desirable flavor constituents of the smoke. In some embodiments, the cavity may include tobacco as an additional flavorant. It should be noted that a cavity insufficiently filled with a chosen substance may lack sufficient interaction between the components of the mainstream smoke and the substance in the cavity.

Some embodiments may involve operably connecting filter rods, filters, filter sections, sectioned filters, and/or sectioned filter rods to a smokeable substance. Some embodiments may involve connecting filter rods, filters, filter sections, sectioned filters, and/or sectioned filter rods to a smokeable substance such that the filter rods, filters, filter sections, sectioned filters, and/or sectioned filter rods are in fluid communication with the smokeable substance.

In some embodiments, a filter rod, a filter, a filter section, a sectioned filter, and/or a sectioned filter rod may be in fluid communication with a smokeable substance. In some embodiments, a smoking device may comprise a filter rod, a filter, a filter section, a sectioned filter, and/or a sectioned filter rod in fluid communication with a smokeable substance. In some embodiments, a smoking device may comprise a housing operably capable of maintaining a filter rod, a filter, a filter section, a sectioned filter, and/or a sectioned filter rod in fluid communication with a smokeable substance. In some embodiments, filter rods, filters, filter sections, sectioned filters, and/or sectioned filter rods may be removable, replaceable, and/or disposable from the housing.

As used herein, the term “smokeable substance” refers to a material capable of producing smoke when burned or heated. Suitable smokeable substances may include, but not be limited to, tobaccos, e.g., bright leaf tobacco, Oriental tobacco, Turkish tobacco, Cavendish tobacco, corojo tobacco, criollo tobacco, Perique tobacco, shade tobacco, white burley tobacco, flue-cured tobacco, Burley tobacco, Maryland tobacco, Virginia tobacco; teas; herbs; carbonized or pyrolyzed components; inorganic filler components; or any combination thereof. Tobacco may have the form of tobacco laminae in cut filler form, processed tobacco stems, reconstituted tobacco filler, volume expanded tobacco filler, or the like. Tobacco, and other grown smokeable substances, may be grown in the United States, or may be grown in a jurisdiction outside the United States.

In some embodiments, a smokeable substance may be in a column format, e.g., a tobacco column. As used herein, the term “tobacco column” refers to the blend of tobacco, and optionally other ingredients and flavorants that may be combined to produce a tobacco-based smokeable article, such as a cigarette or cigar. In some embodiments, the tobacco column may comprise ingredients selected from the group consisting of: tobacco, sugar (such as sucrose, brown sugar, invert sugar, or high fructose corn syrup), propylene glycol, glycerol, cocoa, cocoa products, carob bean gums, carob bean extracts, and any combination thereof. In still other embodiments, the tobacco column may further comprise flavorants, aromas, menthol, licorice extract, diammonium phosphate, ammonium hydroxide, and any combination thereof. In some embodiments, tobacco columns may comprise additives. In some embodiments, tobacco columns may comprise at least one bendable element.

Suitable housings may include, but not be limited to, cigarettes, cigarette holders, cigars, cigar holders, pipes, water pipes, hookahs, electronic smoking devices, roll-your-own cigarettes, roll-your-own cigars, papers, or any combination thereof.

In some embodiments, a pack of filters may comprise filter rods, filters, filter sections, sectioned filters, and/or sectioned filter rods according to any embodiment described herein. Packs may be a hinge-lid pack, a slide-and-shell pack, a hard cup pack, a soft cup pack, or any other suitable pack container. In some embodiments, packs may have an outer wrapping, such as a polypropylene wrapper, and optionally a tear tab. In some embodiments, the filter rods, filters, filter sections, sectioned filters, and/or sectioned filter rods may be sealed as a bundle inside a pack. A bundle may contain any number of filter rods, filters, filter sections, sectioned filters, and/or sectioned filter rods, e.g., 10 or more. However, a bundle may include single filter rods, filters, filter sections, sectioned filters, and/or sectioned filter rods, such as exclusive filter embodiments like those for individual sale, or those comprising a specific spice, like vanilla, clove, or cinnamon.

In some embodiments, a pack of smoking devices may comprise at least one smoking device having a filter rod, a filter, a filter section, a sectioned filter, and/or a sectioned filter rod according to any embodiment described herein. Packs may be a hinge-lid pack, a slide-and-shell pack, a hard cup pack, a soft cup pack, or any other suitable pack container. In some embodiments, the smoking devices may be sealed as a bundle inside a pack. A bundle may contain a number of smoking devices, e.g., 10 or more. However, a bundle may include a single smoking device, in some embodiments, such as exclusive smoking embodiments like a cigar, or a smoking device comprising a specific spice, like vanilla, clove, or cinnamon.

In some embodiments, the present invention provides a carton of smoking device packs that includes at least one pack of smoking devices that includes at least one smoking device having a filter rod, a filter, a filter section, a sectioned filter, and/or a sectioned filter rod according to any embodiment described herein. In some embodiments, the carton (e.g., a container) has the physical integrity to contain the weight from the packs of cigarettes. This may be accomplished through thicker cardstock being used to form the carton or stronger adhesives being used to bind elements of the carton.

Because it is expected that a consumer will smoke a smoking device that includes a filter rod, a filter, a filter section, a sectioned filter, and/or a sectioned filter rod according to any embodiment described herein, the present invention also provides methods of smoking such a smoking device. For example, in one embodiment, the present invention provides a method of smoking a smoking device comprising: heating or lighting a smoking device to form smoke, the smoking device comprising a filter rod, a filter, a filter section, a sectioned filter, and/or a sectioned filter rod according to any embodiment described herein; and drawing the smoke through the smoking device, wherein the filter rod, the filter, the filter section, the sectioned filter, and/or the sectioned filter rod reduces the presence of at least one component in the smoke stream. In some embodiments, the smoking device is a cigarette. In other embodiments, the smoking device is a cigar, a pipe, a water pipe, a hookah, an electronic smoking device, a smokeless smoking device, a roll-your-own cigarette, a roll-your-own cigar, or another smoking device.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods may also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A malleable capsule comprising:
(a) a flexible polymer;
(b) a plasticizer;
(c) an ester hydrolysis catalyst disposed within the capsule; and
(d) at least one water permeable coating disposed about the capsule;
wherein a portion of the catalyst is released from the capsule upon exposure of the capsule to water.

2. The capsule of claim 1 wherein the malleable capsule is substantially spherical.

3. The capsule of claim 2 where a spherical diameter of the capsule is in a range from between about 500 microns to about 25 mm.

4. The capsule of claim 1 wherein the flexible polymer is selected from the group consisting of gelatin, locust bean gum, starch, pectin, agar, alginic acid, salts of alginic acid, carrageenans, sorghum, thermal polyaspartate (TPA), polyvinyl alcohol, polyvinyl acetate (PVAc), polylactic acid (PLA), polyglycolic acid (PGA), polybutylene succinate (PBS), polyhydroxyalkanoate (PHA) such as poly-3-hydroxypropionate (p(3-HP)), polycaprolactone (PCL), and any combination thereof or copolymer thereof.

5. The capsule of claim 1 wherein the flexible polymer is present in a range from between about 10 to about 75 weight percent of the capsule.

6. The capsule of claim 1 wherein the plasticizer is selected from the group consisting of sorbitol, glycerin, and mixtures thereof.

7. The capsule of claim 1 wherein the plasticizer is present in a range from between about 5 to about 50 weight percent of the capsule.

8. The capsule of claim 1 wherein the catalyst is selected from the group consisting of an acid, a salt of a polyprotic acid, a base, and a bacterium.

9. The capsule of claim 8 wherein the acid or salt thereof is selected from the group consisting of acetic, ascorbic, ascorbyl-2-phosphate, ascorbyl-2-sulfate, aspartic(aminosuccinic), cinnamic, citric, folic, glutaric, inositol phosphate(phytic acid), lactic, malic(1-hydroxysuccinic), nicotinic(nician), oxalic, succinic, tartaric, boric, hydrochloric, nitric, phosphoric, sulfuric, and combinations thereof.

10. The capsule of claim 1 wherein the catalyst is present in a range from between about 10 to about 90 weight percent of the capsule.

11. The capsule of claim 1 wherein the coating is multilayered.

12. The capsule of claim 11 wherein an inner layer of the multilayered coating comprises a material selected from the group consisting of ethylcellulose, hydroxypropylmethyl cellulose, and combinations thereof.

13. The capsule of claim 11 wherein an outer layer of the multilayered coating comprises cellulose acetate.

14. The capsule of claim 1 further comprising a flavorant.

15. A smoking device filter comprising:
a malleable capsule disposed within a first section of the smoking device filter, the capsule comprising:
(a) a flexible polymer;
(b) a plasticizer;
(c) an ester hydrolysis catalyst disposed within the capsule; and
(d) at least one water permeable coating disposed about the capsule;
wherein a portion of the catalyst is released from the capsule upon exposure of the capsule to water.

16. The smoking device filter of claim 15 wherein the malleable capsule is substantially spherical.

17. The smoking device filter of claim 16 where a spherical diameter of the capsule is in a range from between about 500 microns to about 25 mm.

18. The smoking device filter of claim 15 wherein the flexible polymer is selected from the group consisting of gelatin, locust bean gum, starch, pectin, agar, alginic acid, salts of alginic acid, carrageenans, sorghum, polyvinyl alcohol (PVA), polyvinyl acetate, polylactic acid (PLA), polyglycolic acid (PGA), polybutylene succinate (PBS), polyhydroxyalkanoate (PHA), poly-3-hydroxypropionate (p(3-HP)), polycaprolactone (PCL), and any combination thereof or copolymer thereof.

19. The smoking device filter of claim 15 wherein the flexible polymer is present in a range from between about 10 to about 75 weight percent of the capsule.

20. The smoking device filter of claim 15 wherein the plasticizer is selected from the group consisting of sorbitol, glycerin, and mixtures thereof.

21. The smoking device filter of claim 15 wherein the plasticizer is present in a range from between about 5 to about 50 weight percent of the capsule.

22. The smoking device filter of claim 15 wherein the catalyst is selected from the group consisting of an acid, a salt of a polyprotic acid, a base, and a bacterium.

23. The smoking device filter of claim 22 wherein the acid or salt thereof is selected from the group consisting of acetic, ascorbic, ascorbyl-2-phosphate, ascorbyl-2-sulfate, aspartic(aminosuccinic), cinnamic, citric, folic, glutaric, inositol phosphate(phytic acid), lactic, malic(1-hydroxysuccinic), nicotinic(nician), oxalic, succinic, tartaric, boric, hydrochloric, nitric, phosphoric, sulfuric, and combinations thereof.

24. The smoking device filter of claim 15 wherein the catalyst is present in a range from between about 10 to about 90 weight percent of the capsule.

25. The smoking device filter of claim 15 wherein the coating is multilayered.

26. The smoking device filter of claim 25 wherein an inner layer of the multilayered coating comprises a material selected from the group consisting of hydroxypropylmethyl cellulose, ethylcellulose, and combinations thereof.

27. The smoking device filter of claim 25 wherein an outer layer of the multilayered coating comprises cellulose acetate.

28. The smoking device filter of claim 15 further comprising a cellulose acetate tow disposed within the first section of the smoking device filter, the capsule disposed within the tow.

29. The smoking device filter of claim 15 further comprising a porous mass comprising an active particle and a binder particle disposed within a second section of the smoking device filter.

30. The smoke device filter of claim 15 further comprising an additive selected from the group consisting of activated carbon, an ion exchange resin, a desiccant, a silicate, a molecular sieve, a silica gel, activated alumina, a zeolite, perlite, sepiolite, Fuller's Earth, magnesium silicate, a metal oxide, iron oxide, activated carbon, a nanoparticle, and combinations thereof.

31. A smoking device comprising:
a smoking device filter comprising a malleable capsule disposed within a first section of the smoking device filter, the capsule comprising:
(a) a flexible polymer;
(b) a plasticizer;
(c) an ester hydrolysis catalyst disposed within the capsule;
wherein a portion of the catalyst is released from the capsule upon exposure of the capsule to water; and
(d) at least one water permeable coating disposed about the capsule;
wherein the smoking device further comprises a housing capable of maintaining a smokeable substance in fluid contact with the smoking device filter.

32. The smoking device of claim 31 wherein the smoking device filter has a diameter from about 0.5 mm to about 10 mm and a length from about 5 mm to about 35 mm.

33. The smoking device of claim 31 wherein the smokeable substance is in the form of a tobacco column.

34. The smoking device of claim 31 wherein the malleable capsule is substantially spherical.

35. The smoking device of claim 34 where a spherical diameter of the capsule is in a range from between about 500 microns to about 25 mm.

36. The smoking device of claim 31 wherein the flexible polymer is selected from the group consisting of gelatin, locust bean gum, starch, pectin, agar, alginic acid, salts of alginic acid, carrageenans, sorghum, polyvinyl alcohol (PVA), polyvinyl acetate, polylactic acid (PLA), polyglycolic acid (PGA), polybutylene succinate (PBS), polyhydroxyalkanoate (PHA), poly-3-hydroxypropionate (P(3-HP)), polycaprolactone (PCL), and any combination thereof or copolymer thereof.

37. The smoking device filter of claim 31 wherein the flexible polymer is present in a range from between about 10 to about 75 weight percent of the capsule.

38. The smoking device filter of claim 31 wherein the plasticizer is selected from the group consisting of sorbitol, glycerin, and mixtures thereof.

39. The smoking device filter of claim 31 wherein the plasticizer is present in a range from between about 5 to about 50 weight percent of the capsule.

40. The smoking device filter of claim 31 wherein the catalyst is selected from the group consisting of an acid, a salt of a polyprotic acid, a base, and a bacterium.

41. The smoking device filter of claim 40, wherein the acid or salt thereof is selected from the group consisting of acetic, ascorbic, ascorbyl-2-phosphate, ascorbyl-2-sulfate, aspartic(aminosuccinic), cinnamic, citric, folic, glutaric, inositol phosphate(phytic acid), lactic, malic(1-hydroxysuccinic), nicotinic(nician), oxalic, succinic, tartaric, boric, hydrochloric, nitric, phosphoric, sulfuric, and combinations thereof.

42. The smoking device filter of claim 31 wherein the catalyst is present in a range from between about 10 to about 90 weight percent of the capsule.

43. The smoking device filter of claim 31 wherein the coating is multilayered.

44. The smoking device filter of claim 43 wherein an inner layer of the multilayered coating comprises a material selected from the group consisting of ethylcellulose, hydroxypropylmethyl cellulose, and combinations thereof.

45. The smoking device filter of claim 43 wherein an outer layer of the multilayered coating comprises cellulose acetate.

46. The smoking device filter of claim 31 further comprising a cellulose acetate tow disposed within a second section of the smoking device filter.

47. The smoking device filter of claim 31 further comprising a cellulose acetate tow disposed within the first section of the smoking device filter, the capsule disposed within the tow.

48. The smoking device filter of claim 31 further comprising a porous mass comprising an active particle and a binder particle disposed within a second section of the smoking device filter.
